(19) United States
(12) Patent Application Publication
(10) Pub. No.: US 2016/0024708 A1
(43) Pub. Date: Jan. 28, 2016

(54) CARPET TILES, PRODUCTS, AND METHODS

(71) Applicant: Beaulieu Group, LLC, Dalton, GA (US)

(72) Inventors: Shawn David McGill, Kennesaw, GA (US); Anders B. Ostman, Acworth, GA (US)

(21) Appl. No.: 14/808,330

(22) Filed: Jul. 24, 2015

Related U.S. Application Data
(60) Provisional application No. 62/028,842, filed on Jul. 25, 2014.

(51) Int. Cl. D06N 7/00; B32B 5/02; B32B 3/26

(52) U.S. Cl. CPC D06N 7/0071; D06N 7/0097; B32B 3/266; B32B 5/02; B32B 2250/02; B32B 2471/02

(57) ABSTRACT

Carpet tiles and products include a structured backing layer having a plurality of holes arranged therethrough. The holes may be sized and arranged over the backing layer to impart the desired properties to the carpet product. For example, the holes preferably are sized and arranged to be effective to mitigate moisture from a flooring installation and/or to alleviate manufacturing tensions in the carpet tile. Methods of manufacturing such carpet tiles and products, as well as methods of using such tiles and products to mitigate moisture and/or alleviate manufacturing tensions, are also provided. In one aspect, carpet tiles include a structured backing layer and a face fabric associated with the structured backing layer. The structured backing layer may include a plurality of holes extending across a thickness of the structured backing layer. The holes may each extend from one surface of the structured backing layer to the opposite surface of the structured backing layer, thereby creating passages therethrough.

This application claims benefit and priority to U.S. Provisional Application No. 62/028,842 filed on Jul. 25, 2014, entitled: CARPET TILES, PRODUCTS AND METHODS, the disclosure of which is incorporated by reference herein in its entirety.

### TECHNICAL FIELD

The present disclosure relates generally to flooring systems, and particularly to carpet tiles, products, and methods for their manufacture and use.

### BACKGROUND

Carpet tiles are becoming an increasingly popular type of flooring for various settings, due to their ease of installation and portability, as compared to traditional broadloom carpets. However, unlike traditional broadloom carpets, carpet tiles suffer from certain issues due to their material structure. For example, carpet tiles may suffer from installation limitations and performance issues.

With traditional broadloom carpet, moisture within or on the subfloor is able to be dissipated through the carpet due to the open structure of the backing material. Carpet tiles utilize different backing materials, typically closed cell foam cushions and/or hardback polymer backings, which do not have the same vapor transmission properties as traditional broadloom backings. As such, moisture present within or on the subfloor beneath carpet tiles is unable to dissipate, and often causes issues such as mildew and interference with adhering the tiles to the subfloor.

In particular, in new building construction it is increasingly common for carpet or carpet tiles to be installed upon installation of the subfloor without allowing for adequate cure time. For example, carpet or carpet tiles are often laid shortly after a concrete subfloor is laid. Even with the use of sealants or with adequate curing time, concrete floors can present an unacceptable moisture condition by allowing excessive amounts of moisture vapor to pass through to the surface. Vapor emission from concrete sub floors can destroy adhesives and cause carpet tile installation failure. As such, there is a need to mitigate moisture during carpet tile installation and/or speed up the curing rate of adhesives used to install carpet tiles.

Another common problem with carpet tiles is the presence of “manufacturing tensions” in the backing layer(s) due to the way the backing materials set during production. These manufacturing tensions may cause reduced dimensional stability of the overall tile, tile shrinkage, doming, cupping, and puckering/curling of the tile, such as at the corners. Manufacturing tensions may be relieved at the installation site using a “back breaking machine” configured to relax the tile backing by bending it in one or more directions. However, such machines are cumbersome and the back breaking process is time-consuming and not always effective, especially when performed at an installation site. Alternatively, installers may discard tiles displaying manufacturing tensions and replace them with other tiles.

Accordingly, it would be desirable to provide improved carpet tiles, products, and methods for their use and manufacture, which are capable of mitigating moisture from the subfloor, providing increased dimensional stability, and/or reducing tile curling, puckering, and shrinkage.

### SUMMARY

In one aspect, a carpet tile is provided that comprises a structured backing layer; and a face fabric associated with the structured backing layer, wherein the structured backing layer comprises a plurality of holes extending across a thickness of the structured backing layer. The size and arrangement of the plurality of holes in the structured backing layer are effective to provide moisture transmission from a subfloor on which the carpet tile is laid. The size and arrangement of the plurality of holes in the structured backing layer are effective to alleviate manufacturing tensions present in the carpet tile. The structured backing layer may comprise a material that is substantially moisture impermeable. The structured backing layer may comprise a hardback tile backing. The structured backing layer may comprise a foam cushion. The structured backing layer may comprise a material selected from the group consisting of PETs, PVCs, urethanes, bitumens, polyethylenes, polyolefins, and combinations thereof. The face fabric may comprise a fabric structure selected from the group consisting of tufted, needled, fusion bonded, flocked, and combinations thereof.

The plurality of holes may extend across the thickness of the structured backing layer, without extending across a thickness of the face fabric. The plurality of holes may extend across the thickness of the structured backing layer and across a thickness of the face fabric. The plurality of holes may have a diameter of from about 0.25 mm to about 3 mm. The plurality of holes may be arranged in the structured backing layer in a grid pattern comprising rows and columns, such that the holes of adjacent rows are substantially aligned and the holes of adjacent columns are substantially aligned. The plurality of holes may be arranged in the structured backing layer in a grid pattern comprising rows and columns, such that the holes of adjacent rows are offset from one another and the holes of adjacent columns are offset from one another. Moreover, a flooring system may comprise a plurality of carpet tiles.

In one aspect, a method of alleviating manufacturing tensions in a pre-formed carpet tile includes the step of forming a plurality of holes in a structured backing layer of a preformed carpet tile, wherein the holes extend across a thickness of the structured backing layer, the size and arrangement of the holes in the structured backing layer being effective to alleviate manufacturing tensions present in the preformed carpet tile. The plurality of holes may extend across the thickness of the structured backing layer, without extending across a thickness of a face fabric associated therewith. The plurality of holes may extend across the thickness of the structured backing layer and across a thickness of a face fabric associated therewith. The plurality of holes may have a diameter of from about 0.25 mm to about 3 mm. The plurality of holes may be arranged in the structured backing layer in a grid pattern comprising rows and columns, such that the holes of adjacent rows are substantially aligned and the holes of adjacent columns are substantially aligned. The plurality of holes maybe arranged in the structured backing layer in a grid pattern comprising rows and columns, such that the holes of adjacent rows are offset from one another and the holes of adjacent columns are offset from one another. The plurality of holes may be sized and arranged in the structured backing layer such that the carpet tile has less than 0.04 percent dimensional change, as measured according to an AACHEN test method.

In one aspect, a method of mitigating moisture in a flooring installation may comprise the step of laying one or more carpet tiles on a subfloor comprising excess moisture, the one or more carpet tiles each comprising a structured backing layer and a face fabric associated with the structured backing layer, wherein the structured backing layer comprises a plurality of holes extending across a thickness of the structured backing layer, the size and arrangement of the holes in the structured backing layer being effective to allow the excess moisture to evaporate from the subfloor. The subfloor may comprise concrete. The method may further comprise applying an adhesive to the subfloor, to a bottom surface of the one or more carpet tiles, or to both, to adhere the carpet tiles to the subfloor. The holes may have a size and arrangement in the structured backing layer effective to increase a curing rate of the adhesive.

In one aspect, a method of alleviating manufacturing tensions in a preformed carpet tile comprises forming a plurality of holes in a structured backing layer of a preformed carpet tile, wherein the holes extend across a thickness of the structured backing layer, the size and arrangement of the holes in the structured backing layer being effective to alleviate manufacturing tensions present in the preformed carpet tile. Forming the plurality of holes in the structured backing layer may comprise contacting a plate comprising a plurality of pins with the surface of the structured backing layer and pressing the plate such that the plurality of holes is formed. Pressing the plate may comprise pneumatically or mechanically pressing the plate. The structured backing layer may comprise a hardback tile backing. The structured backing layer may comprise a foam cushion. The structured backing layer may comprise a material selected from the group consisting of PETs, PVCs, urethanes, bitumens, polyolefins, and combinations thereof.

The holes may extend across the thickness of the structured backing layer, without extending across a thickness of a face fabric associated therewith. The holes may extend across the thickness of the structured backing layer and across a thickness of a face fabric associated therewith. The holes may have a diameter of from about 0.25 mm to about 3 mm. The holes may have a diameter of from about 1 mm to about 2.5 mm. The holes may have a diameter of from about 0.5 mm to about 1.5 mm. The holes may have a diameter of from about 1 mm to about 1.6 mm. The holes may have a diameter of about 1 mm. The holes may have a diameter of about 2.5 mm. Preferably, the holes may have a diameter of about 1.5 mm. The holes may be arranged in the structured backing layer in a grid pattern comprising rows and columns, such that the holes of adjacent rows are substantially aligned and the holes of adjacent columns are substantially aligned. The holes may be arranged in the structured backing layer in a grid pattern comprising rows and columns, such that the holes of adjacent rows are offset from one another and the holes of adjacent columns are offset from one another. Within each row, each hole may be spaced from an adjacent hole by a spacing distance of from about 1 inch to about 10 inches, and within each column, each hole may be spaced from an adjacent hole by the spacing distance. Within each row, each hole may be spaced from an adjacent hole by a spacing distance of from about 1 inch to about 6 inches, and within each column, each hole is spaced from an adjacent hole by the spacing distance. Within each row, each hole may be spaced from an adjacent hole by a spacing distance of about 4 inches, and within each column, each hole may be spaced from an adjacent hole by the spacing distance. Within each row, each hole is spaced from an adjacent hole by a spacing distance of about 2 inches, and within each column, each hole is spaced from an adjacent hole by the spacing distance. The holes may be arranged in the structured backing layer in a variably spaced arrangement.

The thickness of the structured backing layer may be from about 0.5 mm to about 10 mm. The thickness of the structured backing layer may be from about 1 mm to about 7 mm. The holes may be sized and arranged in the structured backing layer such that the carpet tile has less than 0.07 percent dimensional change, as measured according to an AACHEN test method. The holes may be sized and arranged in the structured backing layer such that the carpet tile has less than 0.04 percent dimensional change, as measured according to an AACHEN test method. The structured backing layer may comprise a hardback tile backing and the holes are sized and arranged in the structured backing layer such that the carpet tile has at least 20 percent less dimensional change than a comparable hardback carpet tile without holes, as measured according to an AACHEN test method. The structured backing layer may comprise a hardback tile backing and the holes may be sized and arranged in the structured backing layer such that the carpet tile has at least 40 percent less dimensional change than a comparable carpet tile without holes, as measured according to an AACHEN test method. The structured backing layer may comprise a foam cushion and the holes are sized and arranged in the structured backing layer such that the carpet tile has at least 50 percent less dimensional change than a comparable carpet tile without holes, as measured according to an AACHEN test method. The structured backing layer may comprise a foam cushion and the holes are sized and arranged in the structured backing layer such that the carpet tile has at least 80 percent less dimensional change than a comparable carpet tile without holes, as measured according to an AACHEN test method. The holes may be sized and arranged in the structured backing layer such that the carpet tile has an average edge curl of 0.20 inch or less, as measured according to a test procedure comprising: wetting a surface of the face fabric via cold water extraction; thereafter maintaining the carpet tile at a temperature of 70° F. and a relative humidity of 20 percent for a period of 24 hours; and immediately thereafter laying the carpet tile on a flat surface and measuring a distance of each edge of the carpet tile from the flat surface. The holes may be sized and arranged in the structured backing layer such that the carpet tile has an average edge curl of 0.10 inch or less, as measured according to a test procedure comprising: wetting a surface of the face fabric via cold water extraction; thereafter maintaining the carpet tile at a temperature of 70° F. and a relative humidity of 20 percent for a period of 24 hours; thereafter maintaining the carpet tile at a temperature of 70° F. and a relative humidity of 65 percent for a period of 24 hours, and immediately thereafter laying the carpet tile on a flat surface and measuring a distance of each edge of the carpet tile from the flat surface.

In one aspect, a method of manufacturing a carpet tile comprises the steps of associating a structured backing layer with a face fabric; and forming a plurality of holes in the structured backing layer, wherein the holes extend across a thickness of the structured backing layer. The structured backing layer with the face fabric may comprise lamination of the face fabric to the structured backing layer. The structured backing layer with the face fabric may comprise applying a molten structured backing material to a surface of the face fabric and allowing the backing material to cure. Forming the holes in the structured backing layer may occur after the backing material has cured. Forming the holes in the structured backing layer may occur after the structured backing layer has been associated with the face fabric. Forming the plurality of holes in the structured backing layer may comprise contacting a plate comprising a plurality of pins with a surface of the structured backing layer and pressing the plate such that the plurality of holes is formed. Pressing the plate may comprise pneumatically or mechanically pressing the plate. The holes may be sized and arranged in the structured backing layer such that the carpet tile has an average edge curl of 0.20 inch or less, as measured according to a test procedure comprising: wetting a surface of the face fabric via cold water extraction; thereafter maintaining the carpet tile at a temperature of 70° F. and a relative humidity of 20 percent for a period of 24 hours; and immediately thereafter laying the carpet tile on a flat surface and measuring a distance of each edge of the carpet tile from the flat surface. The holes may be sized and arranged in the structured backing layer such that the carpet tile has an average edge curl of 0.10 inch or less, as measured according to a test procedure comprising: wetting a surface of the face fabric via cold water extraction; thereafter maintaining the carpet tile at a temperature of 70° F. and a relative humidity of 20 percent for a period of 24 hours; thereafter maintaining the carpet tile at a temperature of 70° F. and a relative humidity of 65 percent for a period of 24 hours; and immediately thereafter laying the carpet tile on a flat surface and measuring a distance of each edge of the carpet tile from the flat surface. The carpet tile may have a water vapor emission of 30 grains/m²/day or more. The carpet tile may have a water vapor emission of 35 grains/m²/day or more. The carpet tile may have a permeance of 1.5 perm or more. The carpet tile may have a permeance of 2 perm or more. The carpet tile may have a water vapor emission of 30 grains/m²/day or more. The carpet tile may have a water vapor emission of 35 grains/m²/day or more. The carpet tile may have a permeance of 1.5 perm or more. The carpet tile may have a permeance of 2 perm or more. The carpet tile may have a water vapor emission of 30 grains/m²/day or more.

In one aspect, a carpet product is provided comprising a structured layer backing and a face fabric associated with the structured backing layer, wherein the structured backing layer comprises a plurality of holes extending across a thickness of the structured backing layer.

In one aspect, a method of manufacturing a carpet product may include the steps of associating a structured backing layer with a face fabric and forming a plurality of holes in the structured backing layer, wherein the holes extend across a thickness of the structured backing layer. The structured backing layer with the face fabric may comprise lamination of the face fabric to the structured backing layer. The structured backing layer with the face fabric may comprise applying a molten structured backing material to a surface of the face fabric and allowing the backing material to cure. Forming the holes in the structured backing layer occurs after the backing material has cured. Forming the holes in the structured backing layer occurs after the structured backing layer has been associated with the face fabric. Forming the plurality of holes in the structured backing layer comprises contacting a plate comprising a plurality of pins with a surface of the structured backing layer and pressing the plate such that the plurality of holes is formed. A size and arrangement of the holes in the structured backing layer may be effective to provide moisture transmission from a subfloor on which the carpet product is laid. The size and arrangement of the holes in the structured backing layer may be effective to alleviate manufacturing tensions present in the carpet product prior to formation of the holes therein. The structured backing layer may comprise a hardback backing, a foam cushion, or both. The structured backing layer comprises a material selected from the group consisting of PETs, PVCs, urethanes, bitumens, polyolefin, and combinations thereof. The face fabric may comprise a fabric structure selected from the group consisting of tufted, needled, fusion bonded, flocked, and combinations thereof. The face fabric may comprise fibers selected from the group consisting of nylon 6, nylon 6,6, polyester, polypropylene, wool, and combinations thereof. The holes may extend across the thickness of the structured backing layer, without extending across a thickness of a face fabric associated therewith. The holes may extend across the thickness of the structured backing layer and across a thickness of a face fabric associated therewith. The thickness of the structured backing layer may be from about 0.5 mm to about 10 mm. The thickness of the structured backing layer may be from about 1 mm to about 7 mm. The carpet product may have a water vapor emission of 30 grains/m²/day or more. The carpet product may have a water vapor emission of 35 grains/m²/day or more. The carpet product may have a permeance of 1.5 perm or more. The carpet product may have a permeance of 2 perm or more. The carpet may have a width of 6 feet.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1A is a perspective view and FIG. 1B is a side-view of an example carpet product showing holes extending across a thickness of the backing layer and in a grid pattern, configured according to the principles of the disclosure.

FIG. 2 is a perspective view of an example carpet product with adjacent rows offset from one another, configured according to the principles of the disclosure;

FIG. 3 is a perspective view of an example carpet product showing holes extending across the thickness of a structured backing layer, configured according to the principles of the disclosure;

FIG. 4 is an example of a flooring system comprising a plurality of carpet tiles, configured according to the principles of the disclosure;

FIG. 5 is an example of a carpet tile configured according to the principles of the disclosure,

FIG. 6 is another example of a carpet tile comprising multiple layers, configured according to the principles of the disclosure;

FIG. 7 is another example of a carpet tile comprising multiple layers, configured according to the principles of the disclosure; and

FIGS. 8A-8C show examples of different patterns of holes that may be employed in certain carpet products described herein, according to the principles of the disclosure.

### DETAILED DESCRIPTION

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise. The term “about” herein means within +/−10%, unless context states otherwise.

Although process steps, method steps, or the like, may be described in a sequential order, such processes and methods may be configured to work in alternate orders. In other words, any sequence or order of steps that may be described does not necessarily indicate a requirement that the steps be performed in that order. The steps of the processes or methods described herein may be performed in any order practical. Further, some steps may be performed simultaneously.

When a single layer or article is described herein, it will be readily apparent that more than one layer or article may be used in place of a single layer or article. The functionality or the features of a layer or article may be alternatively embodied by one or more other layers or articles which are not explicitly described as having such functionality or features.

Carpet tiles, products, and flooring systems have been developed to meet one or more of the above-described needs. In particular, carpet tiles and products that are capable of mitigating moisture from the subfloor, providing increased dimensional stability, and/or reducing tile curling, puckering, and shrinkage have been developed.

Generally, carpet tiles and products according to the present disclosure include a structured backing layer having a plurality of holes arranged therethrough. The holes may be sized and arranged over the backing layer to impart the desired properties to the carpet product. For example, the holes preferably are sized and arranged to be effective to mitigate moisture from a flooring installation and/or to alleviate manufacturing tensions in the carpet tile.

Methods of manufacturing such carpet tiles and products, as well as methods of using such tiles and products to mitigate moisture and/or alleviate manufacturing tensions, are also provided herein.

Carpet Tiles, Products & Flooring Systems:

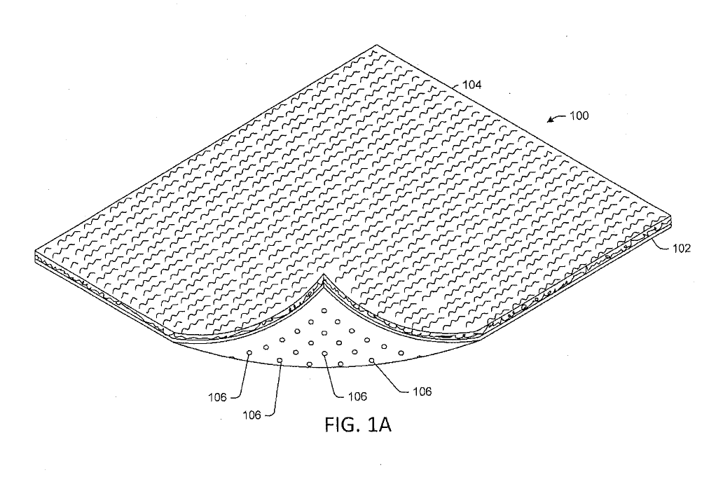

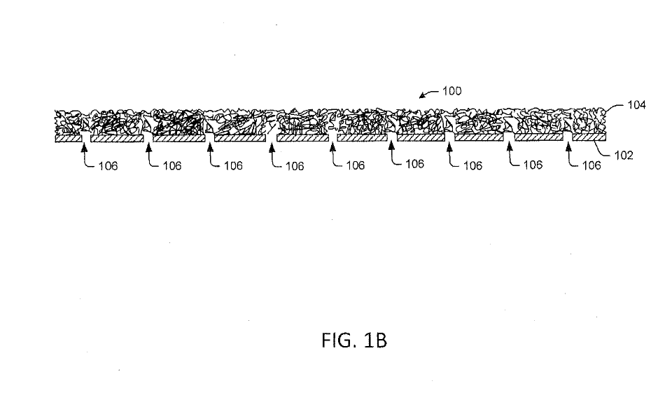

In one aspect, as shown in FIGS. 1A and 1B, carpet tiles 100 are provided, including a structured backing layer 102 and a face fabric 104 associated with the structured backing layer 102. The structured backing layer 102 includes a plurality of holes 106 extending across a thickness of the structured backing layer 102. That is, the holes each extend from one surface of the structured backing layer to the opposite surface of the structured backing layer, thereby creating passages therethrough.

In another aspect, carpet products are provided, including a structured backing layer and a face fabric associated with the structured backing layer. The structured backing layer includes a plurality of holes extending across a thickness of the structured backing layer. The carpet product may be a carpet that is not a carpet tile. It may, for example, be a unitary floor covering. In an embodiment, the carpet product is an intermediate product that is subsequently cut into carpet tiles.

In certain embodiments, sufficient holes are sized and arranged in the structured backing layer to provide moisture transmission from a subfloor on which the carpet tile or product is laid. In certain embodiments, the holes are sized and arranged in the structured backing layer to alleviate manufacturing tensions present in the carpet tile or product. That is, the holes may be configured to provide one or more desired properties to the carpet tile. One or more hole size and pattern arrangements that are configured to achieve the desired property for a specific tile (e.g., materials, structure, dimensions, installation site) may be utilized in a single carpet tile or product. In certain embodiments, the size and arrangement of the holes in the structured backing layer are effective to provide moisture transmission from a subfloor on which the carpet tile or product is laid, to alleviate manufacturing tensions present in the carpet tile or carpet product, or both.

As used herein, the term “structured backing layer” refers to modular carpet tile backing material layers. Various examples of structured backing layers are given throughout this disclosure. However, any suitable modular carpet tile backing material layer known to those of ordinary skill in the art is intended to fall within the scope of this disclosure. Such typical carpet tile backing materials may also be utilized in a wide-style or broadloom carpet product, and the present disclosure is intended to cover such carpet products in addition to carpet tiles. While certain embodiments are described herein in relation to carpet tiles, it is to be understood that such embodiments are also intended to cover other non-tile carpet products having a structured backing layer. For example, a carpet product may be a broadloom carpet, a carpet having a width of about 6 feet, or any other non-tile carpet product having a structured backing layer.

In certain embodiments, the structured backing layer includes a material that is substantially moisture impermeable. As used herein, the term “substantially moisture impermeable” refers to the structured backing layer allowing little or no water to pass through the layer. In one embodiment, the structured backing layer includes a hardback tile backing. As used herein, the term “hardback tile backing” refers to a tile backing that is relatively rigid or hard, such as those formed of a thermoplastic polymer. In one embodiment, the structured backing layer includes a cushion, such as a foam cushion. For example, the foam cushion may be a closed cell foam. Other suitable types of cushions may also be used.

In certain embodiments, the structured backing layer is formed from a material such as PETs, PVCs, urethanes, bitumens, polyethylenes, polyolefins, and combinations thereof. For example, the structured backing layer may include a polyurethane foam cushion or a PET polymer hardback.

In certain embodiments, the thickness of the structured backing is from about 0.5 mm to about 10 mm. In some embodiments, the thickness of the structured backing is from about 1 mm to about 7 mm.

Various examples of carpet tile configurations and structures are given throughout this disclosure. However, any suitable carpet tile design or structure known to those of ordinary skill in the art is intended to fall within the scope of this disclosure. Moreover, the structured backing layers disclosed herein need not be associated only with carpet face fabrics. It is envisioned that the structured backing layers having holes therein may also be associated with other tile facing materials known to those of ordinary skill in the art, such as vinyl, wood, plastic, or other facing materials. For example, a structured backing material having holes therein may be utilized in any flooring or other tile in which alleviation of manufacturing tensions is desirable. Although the tiles disclosed herein are described with respect to carpet or fabric facing materials, it is to be understood that the structured backing layers described herein could be associated with any suitable tile facing materials.

In certain embodiments, the face fabric includes a tufted, needled, fusion bonded, or flocked fabric structure. In certain embodiments, the face fabric includes nylon 6, nylon 6,6, polyester, polypropylene, or wool fibers. The face fabric may also include a primary backing and/or precoat layers.

In certain embodiments, a carpet tile includes one or more additional layers, such as cushion layers, stabilizing layers, reinforcing layers, precoat layers, binder layers, felt backing layers, or secondary backing layers. Suitable known materials, compositions, and fillers (e.g., glass, calcium carbonate, aluminum trihydrate, fly ash) may be used to form the layers of the carpet tiles.

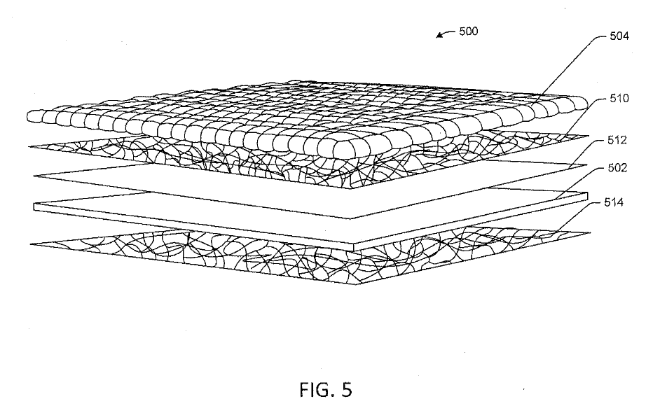

In one embodiment, as shown in FIG. 5, a carpet tile 500 includes a tufted face layer 504, a nonwoven stabilizing layer, such as a polymer (e.g., PET, polypropylene) fiber or fiberglass layer, 510, a binder layer, such as a latex or other adhesive layer (e.g., polyethylene, PVC), 512, a hardback layer, such as a PET or other thermoplastic (e.g., polyethylene, polypropylene) layer, 502, and another nonwoven stabilizing layer 514.

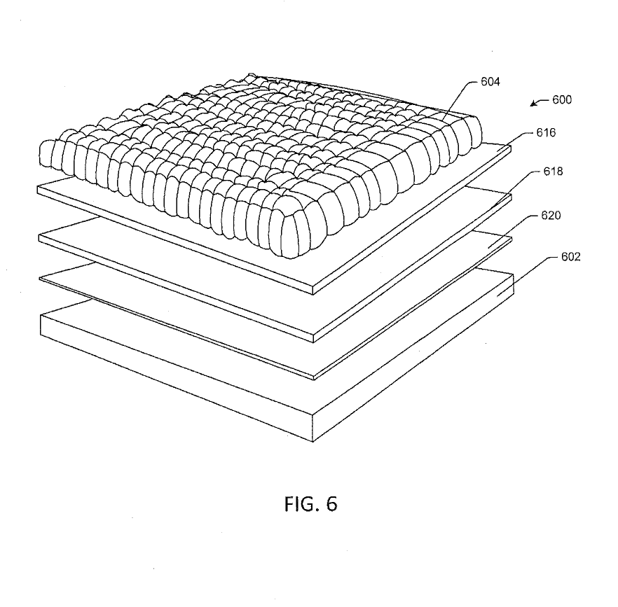

In another embodiment, as shown in FIG. 6, a carpet tile 600 includes a tufted face layer 504, a nonwoven primary backing, such as a nonwoven polymer (e.g., PET) backing, 616, a primary coating layer 618, a secondary backing layer, such as a hot melt, 620, and a structured backing cushion layer, such as a polyurethane foam cushion, 602. In certain embodiments, a felt layer, such as a polymer (e.g., polypropylene, PET) fiber felt, is provided on one surface of the cushion layer, such that the carpet tile is felt-backed.

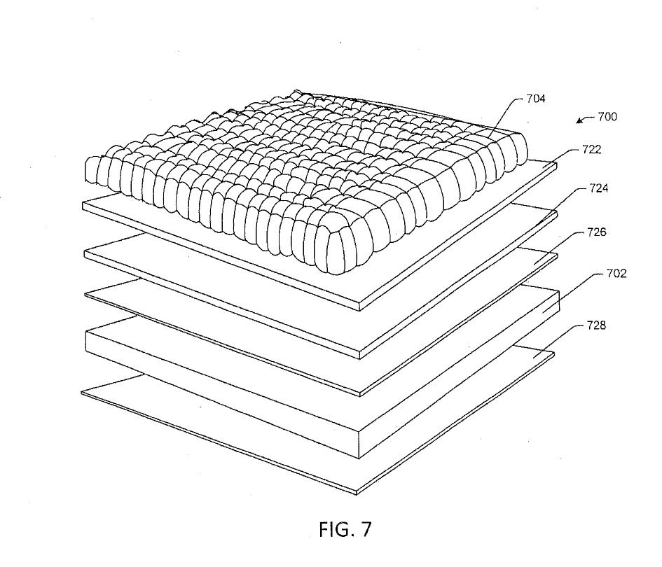

In another embodiment, as shown in FIG. 7, a carpet tile 700 includes a tufted face fabric 704, a primary backing 722, a precoat layer, such as a latex or other suitable adhesive layer, 724, a nonwoven stabilizing layer 726, a structured foam cushion layer 702, and a woven scrim 728.

In certain embodiments, the carpet tile includes a nonwoven cushion layer, such as a needle-punched cushion. A preferred weight for a carpet tile with a cushion layer may be about 1300 osy.

In certain embodiments, the surface of the bottommost layer of the carpet tile (i.e., the surface that will face the subfloor upon installation) includes a pre-applied adhesive, such that the carpet tile is capable of peel-and-stick installation. In other embodiments, the surface of the bottommost layer of the carpet tile (i.e., the surface that will face the subfloor upon installation) includes a material layer configured to optimize bonding between the tile and the installation adhesive.

The carpet tile structures and configurations described herein are meant to be examples only. Other suitable tile structures and designs are intended to fall within the scope of this disclosure.

In certain embodiments, the carpet tile has an overall weight of from about 25 ounces per square yard (osy) to about 250 osy. In some embodiments, the carpet tile has a weight of from about 50 osy to about 150 osy. In one embodiment, the carpet tile has a weight of about 90 osy. In one embodiment, the carpet tile has a weight of about 130 osy.

In certain embodiments, the carpet tile has a tile geometry of an 18 inch square, a 24 inch square, a 36 inch square, or a 36 inch by 18 inch plank. Other tile geometries, including suitable metric geometries, are also envisioned.

In certain embodiments, as shown in FIG. 1B, the holes 106 extend across the thickness of the structured backing layer 102, without extending across a thickness of the face fabric 104. That is, the holes may be dimensioned such that they extend only through the backing layer, do not affect the structural integrity of the face fabric, and are not readily visible, if at all, via the face fabric of the tile.

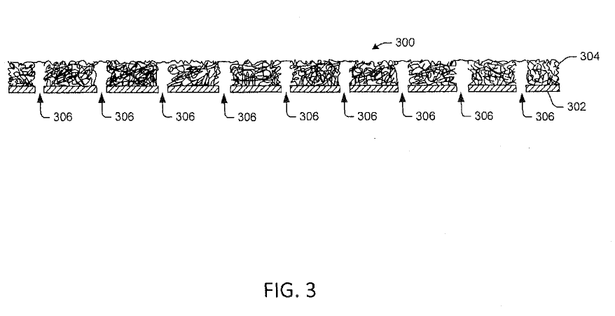

In certain embodiments, as shown in FIG. 3, the holes 306 extend across the thickness of the structured backing layer 302 and across a thickness of the face fabric 304 of the carpet tile 300. That is, the holes may be dimensioned such that they extend through both the backing layer and the face fabric of the carpet tile. For example, in these embodiments, the holes may be sized such that they are not visible via the face fabric of the tile (i.e., they may be so small as to be imperceptible). Depending on the structure of the face fabric, providing holes therein may not affect the structural integrity of the face fabric.

A determining factor in the diameter of the holes may be the number of stitches per square inch in the face fabric. For example, the fewer stitches per square inch, the larger the holes can be without damaging the face appearance and wear properties. For example, a face fabric having a loose construction may not be affected by holes of a relatively small diameter. That is, each hole may pierce all layers of the tile (e.g., the face, primary fabric, backing polymer, any reinforcing substrates, secondary fabric) without damaging the appearance and wear properties of the tile's face fiber. In view of the type of face fabric of a certain tile, the holes may be sized and arranged so as to avoid molting of the face fabric upon formation of the holes in the carpet.

It is to be understood that the holes may be provided through any of the layers of the carpet tile in addition to the structured backing layer. For example, when moisture mitigation is desired, the holes may be provided through all layers of the tile displaying moisture impermeability.

In certain embodiments, the holes may have a diameter of from about 0.25 mm to about 3 mm. For example, the holes may have a diameter of from about 1 mm to about 2.5 mm, of from about 0.5 mm to about 1.5 mm, or of from about 1 mm to about 1.6 mm. In one embodiment, the holes may have a diameter of about 1 mm. In another embodiment, the holes may have a diameter of about 1.5 mm. In yet another embodiment, the holes may have a diameter of about 2.5 mm.

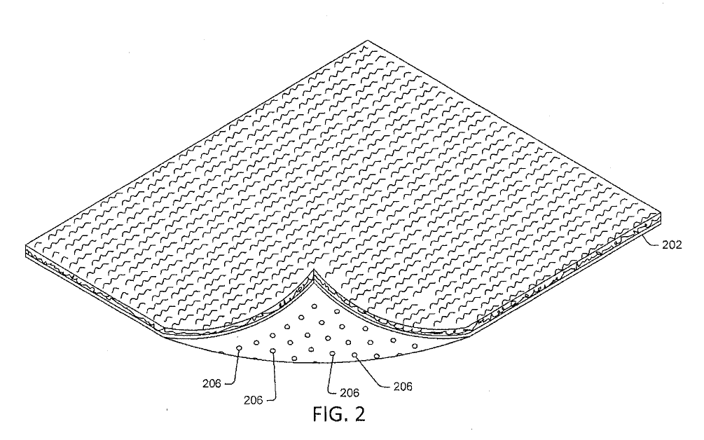

In certain embodiments, as shown in FIG. 1A, the holes 106 are arranged in the structured backing layer 102 in a grid pattern including rows and columns, such that the holes of adjacent rows are substantially aligned and the holes of adjacent columns are substantially aligned. In other embodiments, as shown in FIG. 2, the holes 206 are arranged in the structured backing layer 202 in a grid pattern including rows and columns, such that the holes of adjacent rows are offset from one another and the holes of adjacent columns are offset from one another. In other embodiments, the holes are arranged in the structured backing layer in a variably spaced arrangement. For example, more than one pattern of holes may be provided on a single structured backing layer, to achieve more than one desired effect of the holes.

In certain embodiments, within each row, each hole is spaced from an adjacent hole by a spacing distance of from about 1 inch to about 10 inches, and within each column, each hole is spaced from an adjacent hole by the spacing distance. That is, adjacent holes may be equally spaced from one another by a distance of about 1 to about 10 inches. In certain embodiments, within each row, each hole is spaced from an adjacent hole by a spacing distance of from about 1 inch to about 6 inches, and within each column, each hole is spaced from an adjacent hole by the spacing distance. In one embodiment, within each row, each hole is spaced from an adjacent hole by a spacing distance of about 4 inches, and within each column, each hole is spaced from an adjacent hole by the spacing distance. In another embodiment, within each row, each hole is spaced from an adjacent hole by a spacing distance of about 2 inches, and within each column, each hole is spaced from an adjacent hole by the spacing distance.

In certain embodiments, the holes are arranged to be numerous enough and appropriately sized and dispersed across the surface of the tile to insure adequate ventilation for subfloor moisture and/or installation adhesive. For example, the number of holes and size of holes are proportionally related. That is, the larger the holes, the fewer holes needed to allow adequate ventilation for subfloor moisture and adhesive.

In certain embodiments, the pattern of holes is consistent across each tile to ensure that the manufacturing tension within the tile is evenly released.

For example, depending on the hole diameter and the tile dimensions and structure, the number of holes needed may vary widely. Moreover, different hole sizes and arrangements may be used to achieve moisture remediation versus improved dimensional stability and reduced tensions, as described in additional detail below.

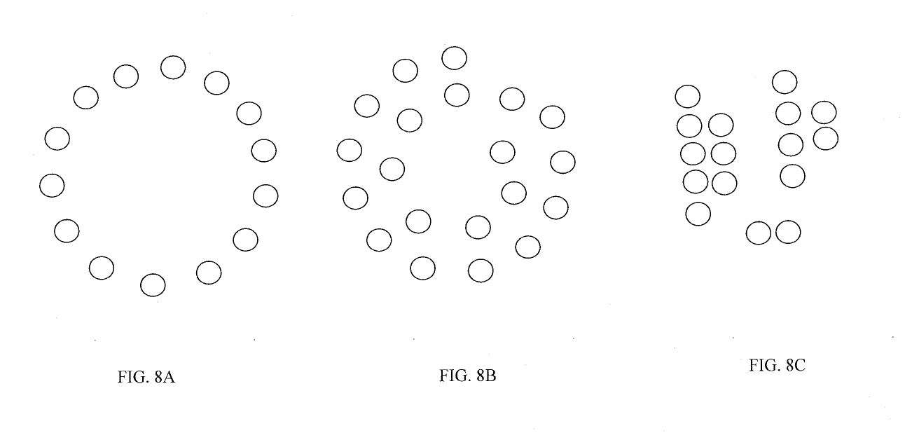

In certain embodiments, the pattern of holes may be a circular pattern, such as shown in FIG. 8A, a spiral type pattern as shown in FIG. 8B or an irregularly spaced pattern as shown in FIG. 8C. Moreover, the holes may be unevenly spaced or evenly spaced. In some embodiments, multiple occurrences of circular patterns and/or multiple patterns of spirals may be employed.

Based on the desired properties of the final carpet tile, as well as the material properties and structure of the tile, the holes may be sized and arranged to achieve certain mechanical properties, described below. For example, the holes may be effective to achieve certain dimensional stability, vapor transmission, and edge curl properties in the carpet tile or product.

In certain embodiments, the carpet tile has less than 0.07 percent dimensional change, as measured according to the AACHEN test method. In certain embodiments, the carpet tile has less than 0.04 percent dimensional change, as measured according to the AACHEN test method.

In certain embodiments, the structured backing layer includes a hardback tile backing and the carpet tile has at least 20 percent less dimensional change than a comparable hardback carpet tile without holes, as measured according to an AACHEN test method. In some embodiments, the structured backing layer includes a hardback tile backing and the carpet tile has at least 40 percent less dimensional change than a comparable carpet tile without holes, as measured according to an AACHEN test method.

In certain embodiments, the structured backing layer includes a cushion and the carpet tile has at least 50 percent less dimensional change than a comparable carpet tile without holes, as measured according to an AACHEN test method. In some embodiments, the structured backing layer includes a cushion and the carpet tile has at least 80 percent less dimensional change than a comparable carpet tile without holes, as measured according to an AACHEN test method.

In certain embodiments, the carpet tile has an average edge curl of 0.20 inch or less, as measured according to a test procedure that includes (i) wetting a surface of the face fabric via cold water extraction; (ii) thereafter maintaining the carpet tile at a temperature of 70° F. and a relative humidity of 20 percent for a period of 24 hours; and (iii) immediately thereafter laying the carpet tile on a flat surface and measuring a distance of each edge of the carpet tile from the flat surface. In some embodiments, the carpet tile has an average edge curl of 0.10 inch or less, as measured according to a test procedure that includes: (i) wetting a surface of the face fabric via cold water extraction; (ii) thereafter maintaining the carpet tile at a temperature of 70° F. and a relative humidity of 20 percent for a period of 24 hours; (iii) thereafter maintaining the carpet tile at a temperature of 70° F. and a relative humidity of 65 percent for a period of 24 hours; and (iv) immediately thereafter laying the carpet tile on a flat surface and measuring a distance of each edge of the carpet tile from the flat surface.

In certain embodiments, the carpet tile has a water vapor emission of 30 grains/m2/day or more. In one embodiment, the carpet tile has a water vapor emission of 35 grains/m2/day or more. In certain embodiments, the carpet tile has a permeance of 1.5 perm or more. In one embodiment, the carpet tile has a permeance of 2 perm or more.

For example, in a particular embodiment, the structured backing layer includes a hardback tile backing and the holes have a diameter of about 1.5 mm and are arranged in the structured backing layer in a grid pattern including rows and columns, such that the holes of adjacent rows are substantially aligned and the holes of adjacent columns are substantially aligned. Within each row, each hole is spaced from an adjacent hole by a spacing distance of about 4 inches, and within each column, each hole is spaced from an adjacent hole by the same spacing distance. In one embodiment, the carpet tile has at least 40 percent less dimensional change than a comparable carpet tile without holes, as measured according to an AACHEN test method.

For example, in another embodiment, the structured backing layer includes a cushion and the holes may have a diameter of about 1 mm and are arranged in the structured backing layer in a grid pattern including rows and columns, such that the holes of adjacent rows are substantially aligned and the holes of adjacent columns are substantially aligned. Within each row, each hole is spaced from an adjacent hole by a spacing distance of about 2 inches, and within each column, each hole is spaced from an adjacent hole by the spacing distance. In one embodiment, the carpet tile has at least 80 percent less dimensional change than a comparable carpet tile without holes, as measured according to an AACHEN test method.

For example, in yet another embodiment, the structured backing layer includes a hardback tile backing and the holes may have a diameter of about 1.25 mm and are arranged in the structured backing layer in a grid pattern including rows and columns, such that the holes of adjacent rows are substantially aligned and the holes of adjacent columns are substantially aligned. Within each row, each hole is spaced from an adjacent hole by a spacing distance of about 2 inches, and within each column, each hole is spaced from an adjacent hole by the spacing distance. In one embodiment, the carpet tile has an average edge curl of 0.20 inch or less, as measured according to a test procedure that includes: (i) wetting a surface of the face fabric via cold water extraction; (ii) thereafter maintaining the carpet tile at a temperature of 70° F. and a relative humidity of 20 percent for a period of 24 hours, and (iii) immediately thereafter laying the carpet tile on a flat surface and measuring a distance of each edge of the carpet tile from the flat surface. In one embodiment, the carpet tile has an average edge curl of 0.10 inch or less, as measured according to a test procedure that includes: (i) wetting a surface of the face fabric via cold water extraction; (ii) thereafter maintaining the carpet tile at a temperature of 70° F. and a relative humidity of 20 percent for a period of 24 hours; (iii) thereafter maintaining the carpet tile at a temperature of 70° F. and a relative humidity of 65 percent for a period of 24 hours; and (iv) immediately thereafter laying the carpet tile on a flat surface and measuring a distance of each edge of the carpet tile from the flat surface.

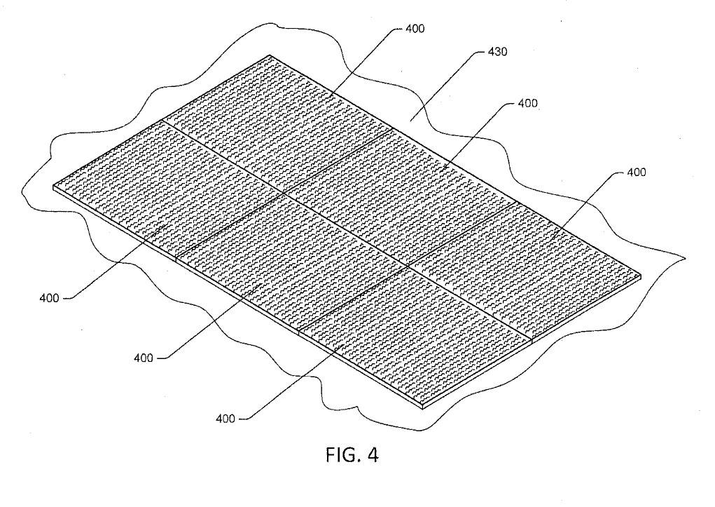

In another aspect, a flooring system is provided. As shown in FIG. 4, the flooring system may include a plurality of carpet tiles 400, as described herein. The flooring system may also include a subfloor 430 on which the plurality of carpet tiles is laid. In one embodiment, the subfloor is concrete in need of moisture mitigation.

Methods of Mitigating Moisture in Flooring Installations:

In one aspect, methods of mitigating moisture in a flooring installation are provided. As shown in FIG. 4, the methods may include laying one or more carpet tiles 400 on a subfloor 430 comprising excess moisture, wherein the one or more carpet tiles each include a structured backing layer and a face fabric associated therewith and the structured backing layer includes a plurality of holes extending across a thickness of the structured backing layer, size and arrangement of the holes in the structured backing layer being effective to allow moisture to evaporate from the subfloor 430. The carpet tiles may include any of the tile features, or combinations of features, described herein.

As explained above, because carpet tiles utilize different backing materials (typically closed cell foam cushions and/or hardback polymer backings) they do not display the same vapor transmission properties as traditional broadloom carpets. As such, moisture present on the subfloor beneath carpet tiles or products is unable to dissipate, and often causes issues such as mildew and interference with adhering the tiles to the subfloor.

In certain embodiments, the subfloor is concrete. For example, carpet tiles may be laid shortly after a concrete subfloor is laid. The holes may have a size and arrangement in the structured backing layer effective to increase a curing rate of the adhesive.

In certain embodiments, the methods also include applying an adhesive to the subfloor, to a bottom surface of the one or more carpet tiles, or to both, to adhere the carpet tiles to the subfloor.

Methods of Alleviating Manufacturing Tensions in Carpet Tiles:

In another aspect, methods of alleviating manufacturing tensions in a pre-formed carpet tile or product are provided. In certain embodiments, methods include forming a plurality of holes in a structured backing layer of a preformed carpet tile, wherein the holes extend across a thickness of the structured backing layer and are sized and arranged in the structured backing layer to alleviate manufacturing tensions present in the pre-formed carpet tile. As used herein, the term “pre-formed carpet tile” refers to a carpet tile that has been manufactured prior to processing to alleviate the tensions therein.

In another aspect, methods of producing carpet tiles with reduced manufacturing tensions are provided. In certain embodiments, methods include forming a plurality of holes in a structured backing layer of a carpet tile (e.g., during or post tile-manufacture), wherein the holes extend across a thickness of the structured backing layer and are sized and arranged in the structured backing layer to provide reduced manufacturing tensions. The carpet tiles may include any of the tile features, or combinations of features, described herein.

In certain embodiments, forming the plurality of holes in the structured backing layer includes contacting a plate comprising a plurality of pins with the surface of the structured backing layer and pressing the plate such that the plurality of holes is formed. For example, pressing the plate may include pneumatically or mechanically pressing the plate.

In certain embodiments, the tiles may be manufactured to display certain performance properties, such as dimensional stability and/or reduced edge curl, as described herein. Generally, high quality, durable carpet tiles include backings that display flatness and stability to prevent the tiles from curling or moving over time and dimensional stability to ensure that the tiles do not shrink or expand under varied conditions of humidity and temperature. As discussed above, a common problem with carpet tiles is the presence of “manufacturing tensions” in the backing layer(s) due to the way the backing materials set during production. These manufacturing tensions cause reduced dimensional stability and of the overall tile, tile shrinkage, doming, cupping, and puckering/curling of the tile, such as at the corners.

As such, holes may be formed in tiles according to the methods described herein, to achieve desirable dimensional stability and flatness properties in the carpet tiles. Advantageously, these methods avoid the need for on-site equipment to “break” the tiles displaying manufacturing tensions.

Methods of Manufacturing Carpet Tiles & Products:

In another aspect, methods of manufacturing carpet tiles and carpet products are provided. In certain embodiments, methods include associating a structured backing layer with a face fabric and forming a plurality of holes in the structured backing layer, wherein the holes extend across a thickness of the structured backing layer. Generally, the carpet tiles may be made according to known processes, with the holes being formed in-line or post-manufacture. The carpet tiles and products manufactured according to these methods may include any of the tile features, or combinations of features, described herein.

In one embodiment, associating the structured backing with the face fabric includes lamination of the face fabric to the structured backing. In another embodiment, associating the structured backing with the face fabric includes applying a molten structured backing material to a surface of the face fabric and allowing the backing material to cure.

In certain embodiments, forming the holes in the structured backing layer occurs after the backing material has cured. In certain embodiments, forming the holes in the structured backing layer occurs after the structured backing layer has been associated with the face fabric.

In certain embodiments, forming the plurality of holes in the structured backing layer comprises contacting a plate comprising a plurality of pins with a surface of the structured backing layer and pressing the plate such that the plurality of holes is formed. In one embodiment, pressing the plate comprises pneumatically or mechanically pressing the plate.

In certain embodiments, the size and arrangement of the holes in the structured backing layer are effective to provide moisture transmission from a subfloor on which the carpet tile or product is laid. In certain embodiments, the size and arrangement of the holes in the structured backing layer are effective to alleviate manufacturing tensions present in the carpet tile or product prior to formation of the holes therein.

For example, formation of the holes can be done using a pneumatic press or other mechanical press systems. The press system may include a puncture plate and a release plate. For example, the press system may engage the puncture plate to pierce the carpet material and then engage the release plate to flush carpet material off the puncture plate. Multiple puncture plates for different puncture diameters and different puncture intervals could be used to accommodate different carpet constructions.

For example, formation of the holes could also be performed via other suitable technologies (e.g., excavation, drilling, routing, molding, embossing, or building into backing substrates). Other suitable methods of forming holes in the structured backing layer are also intended to fall within the scope of this disclosure.

In one embodiment, the carpet tiles are manufactured, allowed to cure over a few days, and then the holes are pressed through the backing using a press plate. In another embodiment, the hole forming process is incorporated into the tile manufacture process upstream of the tile cutting step.

### EXAMPLES

Carpet tiles having a structured backing layer with holes extending across the thickness thereof were manufactured according to the methods described herein, as specified below. The tiles were tested for dimensional stability and tile flatness, or edge curl, and compared to similar tiles having no holes therein. The tiles were also tested for water vapor transmission properties. The test methods and results are described in more detail below.

Dimensional Stability Tests:

The AACHEN test method (standardized as ISO 2551) was performed to determine the dimensional stability of the carpet tiles under varying influence of water and temperature. In particular, the AACHEN test determines dimensional changes in the machine and cross directions and distortion likely to occur when floor coverings are exposed to various conditions of moisture and heat.

According to the AACHEN test, the change in measurements of length in the machine direction and in the cross direction of a sample are measured at five points during the test procedure.

First, the samples are acclimatized under standard conditions (20° C.±2° C. and 65% relative humidity) for 72 hours and then measured in both the machine and cross directions to the 0.01 mm. These original measurements are given notations M0 (Machine Direction Original Measurement) and C0 (Cross Direction Original Measurement).

Next, the samples are laid flat in a drying oven and are treated for two hours with revolving air at 60° C.±2° C. Afterwards, the samples are taken out of the oven and brought into the standard climate to cool down. Within 5±1 minute after removal from the oven, the measurements of the samples are determined to the 0.01 mm. These measurements are given notations MT1 and CT1.

Next, the same samples are dipped underwater for 2 hours, using a water basin filled with water of 20° C.±2° C. which contains 0.1% detergent. After two hours, the samples are removed from the water, which is allowed for five minutes to drip off, and the measurements are determined in the machine and cross directions to the 0.01 mm. These measurements are given notations MT2 and CT2.

Next, the samples are treated again in the drying oven for 24 hours with revolving air and added fresh air at 60° C.±2° C. The samples are then taken out of the oven and brought into the standard climate to cool down. Within 5±1 minute after removal from the oven, the measurements of the samples are determined in the machine and cross directions to the 0.01 mm. These measurements are given notations MT3 and CT3.

Last, the same samples are stored for 48 hours in the standard climate (20° C.±2° C. and 65% relative humidity) and then the measurements of the samples in the machine and cross directions are determined to the 0.01 mm. These measurements are given notations MT4 and CT4.

Any change in measurements are stated as the ratio of the change in length to the original length. That is, the percent change in measurements for the different treatment times are calculated by finding the ratio of the difference of the measurement after each treatment and the measurement before any treatment (i.e., MO or CO). For example, the percent change in length in the machine direction after the third measurement can be determined by the formula:

$$\frac{{M}_{T 3} - {M}_{0}}{{M}_{0}} \times 100.$$

In the case of shrinkage after treatment, the result will be a negative amount. In the case of lengthening after treatment, the result will be a positive amount.

Sample 1: Hardbacked Carpet Tile

A PET hardback carpet tile was manufactured and tested according to the foregoing AACHEN test method. The tile had total weight of 90 osy, a nylon 6 face fiber, and holes through the backing arranged in a regular grid pattern and spaced every 4 inches. The holes had a diameter of approximately 0.06 inches. A comparative carpet tile from the same production run, but without holes through the backing, was also tested. The results of the AACHEN tests are given in Tables 1-4 below.

TABLE 1
Comparative Hardback Tile Machine
Direction Measurements (No holes)

| Test Condition | Measurement (in.) | Percent Change |
|---|---|---|
| M₀ | 23.9863 | |
| M_{T1} | 23.9813 | −0.021 |
| M_{T2} | 23.9925 | +0.026 |
| M_{T3} | 23.9850 | −0.005 |
| M_{T4} | 23.9688 | −0.073 |

| | |
|---|---|
| Overall Change | −0.0175 in. |

TABLE 2
Comparative Hardback Tile Cross
Direction Measurements (No holes)

| Test Condition | Measurement (in.) | Percent Change |
|---|---|---|
| C₀ | 23.9800 | |
| C_{T1} | 23.9788 | −0.005 |
| C_{T2} | 24.0050 | +0.104 |
| C_{T3} | 23.9913 | +0.047 |
| C_{T4} | 23.9713 | −0.036 |

| | |
|---|---|
| Overall Change | −0.0087 in. |

TABLE 3
Hardback Tile with Holes Machine Direction Measurements

| Test Condition | Measurement (in.) | Percent Change |
|---|---|---|
| M₀ | 23.9700 | |
| M_{T1} | 23.9713 | +0.005 |
| M_{T2} | 23.9813 | +0.047 |
| M_{T3} | 23.9713 | +0.005 |
| M_{T4} | 23.9613 | −0.037 |

| | |
|---|---|
| Overall Change | −0.0087 in. |

TABLE 4
Hardback Tile with Holes Cross Direction Measurements

| Test Condition | Measurement (in.) | Percent Change |
|---|---|---|
| C₀ | 23.9913 | |
| C_{T1} | 23.9925 | −0.005 |
| C_{T2} | 24.0150 | +0.099 |
| C_{T3} | 23.9925 | +0.005 |
| C_{T4} | 23.9850 | −0.026 |

| | |
|---|---|
| Overall Change | −0.0063 in. |

These results demonstrate that the hardback tile having the holes therein surprisingly showed about 40 percent less shrinkage than identical tiles without holes made in the same production run.

Sample 2: Cushion-Backed Carpet Tile

A cushion-backed carpet tile was manufactured and tested according to the foregoing AACHEN test method. The tile had total weight of 130 osy, a nylon 6 face fiber, and holes through the PET and cushion backing arranged in a regular grid pattern and spaced every 2 inches. The holes had a diameter of approximately 0.04 inches. A comparative carpet tile from the same production run, but without holes through the backing, was also tested. The results of the AACHEN tests are given in Tables 5-8 below.

TABLE 5
Comparative Cushion Backed Tile Machine
Direction Measurements (No holes)

| Test Condition | Measurement (in.) | Percent Change |
|---|---|---|
| M₀ | 23.8775 | |
| M_{T1} | 23.8860 | +0.031 |
| M_{T2} | 23.8713 | −0.026 |
| M_{T3} | 23.8350 | −0.178 |
| M_{T4} | 23.8300 | −0.199 |

| | |
|---|---|
| Overall Change | −0.0475 in. |

TABLE 6
Comparative Cushion Backed Tile Cross
Direction Measurements (No holes)

| Test Condition | Measurement (in.) | Percent Change |
|---|---|---|
| C₀ | 24.0613 | |
| C_{T1} | 24.0513 | 0.000 |
| C_{T2} | 24.0925 | +0.172 |
| C_{T3} | 24.0138 | −0.156 |
| C_{T4} | 24.0188 | −0.135 |

| | |
|---|---|
| Overall Change | −0.0325 in. |

TABLE 7
Cushion-Backed Tile with Holes Machine Direction Measurements

| Test Condition | Measurement (in.) | Percent Change |
|---|---|---|
| M₀ | 24.0413 | |
| M_{T1} | 24.0276 | −0.057 |
| M_{T2} | 24.0813 | +0.166 |
| M_{T3} | 24.0613 | +0.042 |
| M_{T4} | 24.0400 | −0.005 |

| | |
|---|---|
| Overall Change | −0.0013 in. |

TABLE 8
Cushion-Backed Tile with Holes Cross Directions Measurements

| Test Condition | Measurement (in.) | Percent Change |
|---|---|---|
| C₀ | 23.9438 | |
| C_{T1} | 23.0425 | −0.005 |
| C_{T2} | 23.9575 | +0.057 |
| C_{T3} | 23.9388 | −0.021 |
| C_{T4} | 23.9300 | −0.057 |

| | |
|---|---|
| Overall Change | −0.0138 in. |

These results demonstrate that the cushion-backed tile having the holes therein surprisingly showed about 80 percent less shrinkage than identical tiles without holes made in the same production run.

Overall, the dimensional stability tests unexpectedly revealed that certain hole configurations could greatly reduce the amount of shrinkage that occurs in traditional carpet tiles.

Tile Flatness Tests

Tile flatness, or edge curl, was determined using a standard Tile Flatness test method, as described below. In particular, after two conditioning procedures, sample tiles were evaluated for edge curl characteristics that the exposure to the atmospheric conditions might render.

First, the samples were cold water extracted to wet out the surface of the carpet fibers. Next, the damp tiles were air-dried in a face up position at 70° F. and 20 percent relative humidity for a period of 48 hours. After the 48 hours, each sample was laid on a flat surface and the corners of the sample relative to the flat surface were measured using a handheld micrometer. These measurements were averaged and recorded as the edge curl after procedure I.

Next, the samples were placed face up in a conditioned environment maintained at 70° F. and 65 percent relative humidity for an additional 48 hours, after which another set of edge measurements were taken. These measurements were averaged and recorded as the edge curl after procedure II.

Based on the average edge curl measurements, a numerical edge curl rating was assigned to each sample, based on Table 9 below.

TABLE 9
Key to Edge Curl Measurement Ratings

| Numerical | | Measured Edge Curl |
|---|---|---|
| Edge Curl | | Relative to Flat |
| Rating | Description of Edge Curl | Surface (in.) |
| 5 | No edge curl | <.01″ |
| 4 | Slight edge curl | .01″ to .10″ |
| 3 | Moderate edge curl | .11″ to .15″ |
| 2 | Considerable edge curl | .16″ to .20″ |
| 1 | Significant edge curl | >.20″ |

Sample 1: Hardbacked Carpet Tile

A PET hardback carpet tile was manufactured and tested according to the foregoing Tile Flatness test method. The tile had total weight of 90 osy, a nylon 6 face fiber, and holes through the backing arranged in a regular grid pattern and spaced every 2 inches. The holes had a diameter of approximately 0.05 inches. A comparative carpet tile from the same production run, but without holes through the backing, was also tested. The results of the Tile Flatness tests are given in Tables 10 and 11 below.

TABLE 10
Comparative Hardback Tile Flatness Measurements

| Test Condition | Measurement (in.) | Rating |
|---|---|---|
| Edge curl | 0.22 | 1 |
| after procedure I | | |
| Edge curl | 0.05 | 4 |
| after procedure II | | |

TABLE 11
Hardback Tile with Holes Flatness Measurements

| Test Condition | Measurement (in.) | Rating |
|---|---|---|
| Edge curl | 0.05 | 4 |
| after procedure I | | |
| Edge curl | 0.03 | 4 |
| after procedure II | | |

These results demonstrate a reduction of edge curl to only slight curl by configuring holes in the backing of a standard hardbacked tile in which the edge curl was significant.

Overall, the flatness tests surprisingly revealed that certain hole configurations could reduce the edge curl that occurs in traditional carpet tiles.

Water Vapor Transmission Test

Water vapor transmission properties of a PET hardback carpet tile were tested according to ASTM E96. The tile had total weight of 90 osy, a nylon 6 face fiber, and holes through the backing arranged in a regular grid pattern and spaced every 2 inches. The holes had a diameter of approximately 0.05 inches.

The test results showed a water vapor emission of 35.30 grains/m2/24 hours (6.71 lbs/1000 ft2/24 hours) and a permeance of 2.135. These results are much higher than those of comparable tiles without holes, indicating improved breathability or vapor transmission of the tiles with holes.

Without intending to be limited to a particular theory, it is believed that certain configurations of holes in combination with the carpet tile structure reduce the stress that is present in the backing material as a result of the manufacturing process. As such, carpet tiles or other products may be produced, which are capable of mitigating moisture from the subfloor, providing increased dimensional stability, and/or reducing tile curling, puckering, and shrinkage.

While the disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

We claim:

1. A carpet tile, comprising:
a structured backing layer; and
a face fabric associated with the structured backing layer,
wherein the structured backing layer comprises a plurality of holes extending across a thickness of the structured backing layer.

2. The carpet tile of claim 1, wherein the size and arrangement of the plurality of holes in the structured backing layer are effective to provide moisture transmission from a subfloor on which the carpet tile is laid.

3. The carpet tile of claim 1, wherein a size and arrangement of the plurality of holes in the structured backing layer are effective to alleviate manufacturing tensions present in the carpet tile.

4. The carpet tile of claim 1, wherein the structured backing layer comprises a material that is substantially moisture impermeable.

5. The carpet tile of claim 1, wherein the structured backing layer comprises a hardback tile backing.

6. The carpet tile of claim 1, wherein the structured backing layer comprises a foam cushion.

7. The carpet tile of claim 1, wherein the structured backing layer comprises a material selected from the group consisting of PETs, PVCs, urethanes, bitumens, polyethylenes, polyolefins, and combinations thereof.

8. The carpet tile of claim 1, wherein the face fabric comprises a fabric structure selected from the group consisting of tufted, needled, fusion bonded, flocked, and combinations thereof.

9. The carpet tile of claim 1, wherein the plurality of holes extend across the thickness of the structured backing layer, without extending across a thickness of the face fabric.

10. The carpet tile of claim 1, wherein the plurality of holes extend across the thickness of the structured backing layer and across a thickness of the face fabric.

11. The carpet tile of claim 1, wherein the plurality of holes have a diameter of from about 0.25 mm to about 3 mm.

12. The carpet tile of claim 1, wherein the plurality of holes are arranged in the structured backing layer in a grid pattern comprising rows and columns, such that the holes of adjacent rows are substantially aligned and the holes of adjacent columns are substantially aligned.

13. The carpet tile of claim 1, wherein the plurality of holes are arranged in the structured backing layer in a grid pattern comprising rows and columns, such that the holes of adjacent rows are offset from one another and the holes of adjacent columns are offset from one another.

14. A method of alleviating manufacturing tensions in a pre-formed carpet tile, the method comprising the step of:
forming a plurality of holes in a structured backing layer of a pre-formed carpet tile,
wherein the holes extend across a thickness of the structured backing layer, the size and arrangement of the holes in the structured backing layer being effective to alleviate manufacturing tensions present in the pre-formed carpet tile.

15. The method of claim 14, wherein the plurality of holes extend across the thickness of the structured backing layer, without extending across a thickness of a face fabric associated therewith.

16. The method of claim 14, wherein the plurality of holes extend across the thickness of the structured backing layer and across a thickness of a face fabric associated therewith.

17. The method of claim 14, wherein the plurality of holes have a diameter of from about 0.25 mm to about 3 mm.

18. The method of claim 14, wherein the plurality of holes are arranged in the structured backing layer in a grid pattern comprising rows and columns, such that the holes of adjacent rows are substantially aligned and the holes of adjacent columns are substantially aligned.

19. The method of claim 14, wherein the plurality of holes are arranged in the structured backing layer in a grid pattern comprising rows and columns, such that the holes of adjacent rows are offset from one another and the holes of adjacent columns are offset from one another.

20. The method of claim 14, wherein the plurality of holes are sized and arranged in the structured backing layer such that the carpet tile has less than 0.04 percent dimensional change, as measured according to an AACHEN test method.
